(19) United States
(12) Patent Application Publication
(10) Pub. No.: US 2020/0347321 A1
(43) Pub. Date: Nov. 5, 2020

(54) METHODS OF USING ANTIOXIDANTS IN FABRIC TREATMENT COMPOSITIONS FOR TREATING ELASTANE-CONTAINING FABRICS

(71) Applicant: The Procter & Gamble Company, Cincinnati, OH (US)

(72) Inventors: Gregory Scot MIRACLE, Liberty Township, OH (US); Daniel Dale DITULLIO, JR., Hamilton, OH (US); Yuexi WANG, Cincinnati, OH (US)

(21) Appl. No.: 16/864,172

(22) Filed: May 1, 2020

(30) Foreign Application Priority Data
May 3, 2019 (EP) 19172542.3

(51) Int. Cl. C11D 3/00; C11D 3/20; C11D 1/72; C11D 3/50; C11D 3/12; C11D 3/30; C11D 11/00

(52) U.S. Cl. CPC C11D 3/0084; C11D 3/2034; C11D 1/72; C11D 11/0017; C11D 3/1206; C11D 3/30; C11D 3/2079; C11D 3/50

(57) ABSTRACT

A method of treating an elastane-containing fabric. The method including the steps of providing a fabric treatment composition having an antioxidant and a surfactant, and providing an elastane-containing fabric. The method further including the step of contacting the elastane-containing fabric with the fabric treatment composition in the presence of water, wherein the fabric treatment composition and the water form a treatment liquor having an antioxidant concentration of at least 25 ppb, a surfactant concentration of at least 10 ppm, and wherein the ratio of treatment liquor to elastane-containing fabric (w/w) is from 0.1:1 to 100:1. At least some portion of the antioxidant is deposited onto the elastane-containing fabric.

### FIELD OF THE INVENTION

The present disclosure relates to methods of using antioxidants in fabric treatment compositions for treating elastane-containing fabrics particularly for treating elastane-containing fabrics already soiled as well as for treating elastane-containing fabrics that have yet to be soiled.

### BACKGROUND OF THE INVENTION

Garments intended for use as athletic wear are becoming more popular, even for use during non-athletic pursuits. The fabrics of such garments regularly contain elastomeric synthetic fibers, or elastane, (also commonly known as spandex and LYCRA®). Elastane is used for its ability to enable stretch, offering an unrestricted range of motion, and then snapping back in place. Elastane is also breathable, wicks moisture, and dries quickly. Such fabrics typically further comprise either cotton, polyester, nylon, or blends thereof. As these garments are worn, soils and human sebum are transferred to the fabric. Even if soils and sebum are not transferred directly to the fabric during wear, soils and sebum may be transferred from one fabric to another by direct contact, in a hamper for example, or through redistribution of the soils and sebum across fabrics in a wash environment. Such soil and sebum left on the fabrics lead to the production of malodorous materials through spontaneous autoxidation. Malodor is often an indication to consumers that a garment is not clean. Consumers continually express interest in treatment products and methods that remove soils from garments and leave garments smelling pleasant. Manufacturers of consumer cleaning products are continuously seeking to provide treatment compositions and methods that provide improved malodor control or malodor reduction.

While many soils are removed from fabrics by surfactants during a treatment method, often times some soils remain on the fabrics. Current trends in fabric treatment compositions and methods, such as decreased wash temperatures, shorter wash times, lower concentrations of cleaning actives, such as surfactants, and the general trend to use fabric treatment compositions having fewer harsh chemicals, decrease the efficacy of many fabric treatment compositions and methods. As a consequence, the level of incompletely removed soils remaining on fabrics after being treated is increasing.

Further, even when soils and sebum are removed from fabrics during a treatment method or when garments are brand new and considered to be clean, malodor may quickly reappear when the garments are worn or are in direct contact with another garment that is soiled. Consumers may become frustrated at the frequency in which they need to treat their garments to rid the garments of malodor.

Certain antioxidants are known to be used in fabric treatment compositions as malodor reducing agents. Such antioxidants may facilitate malodor reduction by retarding autoxidation events in soils and sebum that lead to the formation of malodorous materials. Antioxidants may be deposited onto fabrics during a fabric treatment method to treat malodor, however, such antioxidants are generally incorporated at low levels within many fabric treatment products and/or are unable to be deposited onto many types of common fabrics. There may be a considerable amount of time, such as several days or even weeks, between when a garment is washed and then worn, and so, a consumer may not enjoy the benefit that they presumed they would when they purchased and used the treatment product.

As such, there is a need for an improved method of treating elastane-containing fabrics that provides malodor benefits for when the elastane-containing fabric is already soiled and for when the elastane-containing fabric has yet to be soiled.

### SUMMARY OF THE INVENTION

The present disclosure relates to a method of treating an elastane-containing fabric. The method comprises the steps of: providing a fabric treatment composition comprising an antioxidant and a surfactant and providing an elastane-containing fabric. The method further comprises the step of contacting the elastane-containing fabric with the fabric treatment composition in the presence of water, wherein the fabric treatment composition and the water form a treatment liquor having an antioxidant concentration of at least 25 ppb, a surfactant concentration of at least 10 ppm, and wherein the ratio of treatment liquor to elastane-containing fabric (w/w) is from 0.1:1 to 100:1. At least some portion of the antioxidant is deposited onto the elastane-containing fabric.

### BRIEF DESCRIPTION OF THE DRAWINGS

FIG. 1 is a graph showing the deposition of antioxidant on various fabrics containing elastane and without elastane.

### DETAILED DESCRIPTION OF THE INVENTION

The present disclosure relates to methods of using antioxidants in fabric treatment compositions for treating elastane-containing fabrics particularly for treating elastane-containing fabrics already soiled as well as for treating elastane-containing fabrics that have yet to be soiled. Applicant has found that treating elastane-containing fabrics with fabric treatment compositions comprising an antioxidant can provide surprising malodor benefits, such as, for example, slowing the formation of malodorous species generated from the autoxidation of soils.

Unsaturated organic soils, such as human sebum, left on a fabric surface are prone to spontaneous autoxidation. Such breakdown of the soils into their oxidation products may release volatile, malodorous compounds. During the propagation stage of autoxidation of soils, the soils are broken down into smaller, lower molecular weight, volatile aldehyde species. Propagation reactions can be repeated many times before termination by conversion of an alkyl or peroxy radical to a nonradical species. Hydrogen-donating antioxidants, such as hindered phenols and secondary aromatic amines, inhibit oxidation by competing with the organic substrates for peroxy radicals. This shortens the kinetic chain length of the propagation reactions. As such, autoxidation is slowed down or halted.

To retard the formation of malodorous species, the antioxidant must effectively deposit onto the fabric. For already soiled fabrics, antioxidants will generally react with the autoxidizable soils to slow down or halt autoxidation. However, for many types of fabrics, once the antioxidant reacts with the autoxidizable soils and results in a clean fabric, any remaining unreacted antioxidant generally has difficulty depositing onto the clean fabric. When there is little to no soil present, such as when a garment is new or has already been cleaned, antioxidants generally have difficulty depositing onto these clean fabrics as well.

Surprisingly, Applicant has found that methods of the present disclosure deliver high levels of antioxidant to elastane-containing fabrics, enabling the antioxidant to effectively deposit onto the fabric when autoxidizable soils are present as well as when there is little to no soil present, or the fabric is clean. By having antioxidant built-up on a fabric, the antioxidant may act on new soils that are subsequently added to the fabric, thereby reducing malodorous species from forming. Consumers may notice that their treated fabrics have reduced malodor for longer periods of time.

Methods of treating elastane-containing fabrics of the present disclosure are described in more detail below.

### I. Definitions

As used herein, the articles “a” and “an” when used in a claim, are understood to mean one or more of what is claimed or described. As used herein, the terms “include,” “includes,” and “including” are meant to be non-limiting. The treatment compositions of the present disclosure can comprise, consist essentially of, or consist of, the components/ingredients of the present disclosure.

As used herein the phrase “fabric treatment composition” includes compositions and formulations designed for treating fabrics, including garments, or other textiles. Such compositions include, but are not limited to, laundry cleaning compositions and detergents, fabric softening compositions, fabric enhancing compositions, fabric freshening compositions, laundry prewash, laundry pretreat, laundry additives, spray products, dry cleaning agent or composition, laundry wash additives, post-rinse fabric treatments, ironing aid, unit dose formulation, delayed delivery formulation, detergent contained on or in a porous substrate or nonwoven sheet, and other suitable forms that may be apparent to one skilled in the art in view of the teachings herein. Such compositions may be used as a pre-laundering treatment, a post-laundering treatment, or may be added during the wash cycle of the laundering operation.

As used herein, “liquid” includes free-flowing liquids, as well as pastes, gels, foams and mousses. Non-limiting examples of liquids include light-duty and heavy-duty liquid detergent compositions, fabric enhancers, detergent gels commonly used for laundry, bleach and laundry additives. Gases, e.g., suspended bubbles, or solids, e.g., particles, may be included within the liquids.

As used herein, a “granule” and a “particle” refer to a volume of solid, or sufficiently solid, material that has finite mass. Granules and particles may be free-flowing or suspended within a secondary composition. Free-flowing particles may be similar to those commercially available under the tradename UNSTOPABLES® from The Procter & Gamble Company, Cincinnati, Ohio, United States.

The terms “substantially free of” or “substantially free from” may be used herein. This means that the indicated material is at the very minimum not deliberately added to the composition to form part of it, or, preferably, is not present at analytically detectable levels. It is meant to include compositions whereby the indicated material is present only as an impurity in one of the other materials deliberately included. The indicated material may be present, if at all, at a level of less than 0.1%, or less than 0.01%, or even 0%, by weight of the composition.

As used herein, the phrases “sufficiently solid” and “solid” mean the material is capable of maintaining its shape without significant deformation when free-standing at room temperature. A “solid” as used herein may include, but is not limited to, granules, particles, powders, agglomerates, micro-capsules, flakes, noodles, pearlized balls, and mixtures thereof.

As used herein, the phrase “water-soluble”, “water-soluble material,” “water-soluble carrier material,” means that the material or carrier material is soluble or dispersible in water, and preferably has a water-solubility of at least 50%, preferably at least 75% or even at least 95%, as measured by the method set out hereafter using a glass-filter with a maximum pore size of 20 microns: 50 grams±0.1 gram of the material and/or carrier material is added in a pre-weighed 400 mL beaker and 245 mL±1 mL of distilled water is added. This is stirred vigorously on a magnetic stirrer set at 600 rpm, for 30 minutes. Then, the mixture is filtered through a sintered-glass filter with a pore size as defined above (max. 20 micron). The steps are performed at ambient conditions. “Ambient conditions” as used herein means 23° C.±1.0° C. and a relative humidity of 50%±2%. The water is dried off from the collected filtrate by any conventional method, and the weight of the remaining material is determined (which is the dissolved or dispersed fraction). Then, the percentage solubility or dispersability can be calculated.

Unless otherwise noted, all component/ingredient or composition levels are in reference to the active portion of that component/ingredient or composition, and are exclusive of impurities, for example, residual solvents or by-products, which may be present in commercially available sources of such components/ingredients or compositions.

All temperatures herein are in degrees Celsius (° C.) unless otherwise indicated. Unless otherwise specified, all measurements herein are conducted at 20° C. and under the atmospheric pressure.

In all embodiments of the present disclosure, all percentages are by weight of the total composition, unless specifically stated otherwise. All ratios are weight ratios, unless specifically stated otherwise.

### II. Method of Treating an Elastane-Containing Fabric

The present disclosure relates to methods of treating an elastane-containing fabric with a fabric treatment composition comprising an antioxidant.

The method comprises the steps of providing a fabric treatment composition comprising an antioxidant and a surfactant and providing an elastane-containing fabric. Such fabric treatment compositions and elastane-containing fabrics are described hereinafter.

The method further comprises the step of contacting the elastane-containing fabric with the fabric treatment composition in the presence of water. The fabric treatment composition and the water together form a treatment liquor. The fabric treatment composition may be diluted and/or dissolved in water external to the fabric treatment composition to form the treatment liquor. Alternatively, the fabric treatment composition may already comprise water sufficient to form a treatment liquor, such as when the fabric treatment composition is in liquid form and is applied as a concentrate. The step of contacting the elastane-containing fabric with the fabric treatment composition in the presence of water may occur in any suitable vessel, such as, for example, a sink, or an automatic washing machine (e.g., a top-loading washing machine or a front-loading washing machine), where the fabric treatment composition is added to the drum of the automatic washing machine. The step of contacting the elastane-containing fabric with the fabric treatment composition in the presence of water may occur as part of the wash cycle of an automatic washing machine. When applied as a concentrate, the step of contacting the elastane-containing fabric with the fabric treatment composition in the presence of water may occur outside of a vessel, such as by simply spraying or applying the concentrate directly onto the elastane-containing fabric. Optionally, the fabric treatment composition may be pre-measured in, for example, a measuring cup, prior to the step of contacting the elastane-containing fabric with the fabric treatment composition in the presence of water. The measuring cup may be separate from the container in which the fabric treatment composition is provided or may be a part of the container in which the fabric treatment composition is provided, if provided in a container, e.g., a cap.

The treatment liquor has an antioxidant concentration of at least 25 ppb, preferably at least 100 ppb, more preferably at least 250 ppb, even more preferably at least 500 ppb, even more preferably at least 1000 ppb. The treatment liquor has a surfactant concentration of at least 10 ppm, preferably at elast 25 ppm, more preferably at least 50 ppm, even more preferably above 100 ppm. Applicant has found that such levels of antioxidant and surfactant in the treatment liquor are effective for treating elastane-containing fabrics that are already soiled as well as elastane-containing fabrics that are not yet soiled.

The ratio of treatment liquor to elastane-containing fabric (w/w) is from 0.1:1 to 100:1. When the fabric treatment composition already comprises water sufficient to form the treatment liquor and is applied as a concentrate, the ratio of treatment liquor to elastane-containing fabric (w/w) may be from 0.1:1 to 1:1, or from 0.25:1 to 0.75:1. When the fabric treatment composition is diluted and/or dissolved in water external to the fabric treatment composition to form the treatment liquor, the ratio of treatment liquor to elastane-containing fabric (w/w) may be from 1:1 to 100:1, or from 5:1 to 90:1, or from 10:1 to 80:1. Applicant has found that such weight ratios of treatment liquor to elastane-containing fabric provides suitable levels of antioxidant to be able to deposit onto the elastane-containing fabric and provide a long-lasting benefit of malodor reduction on the elastane-containing fabric.

When the elastane-containing fabric is contacted with the fabric treatment composition in the presence of water, at least some portion of the antioxidant is deposited onto the elastane-containing fabric. For example, at least 1 μg/g, preferably at least 2 μg/g, more preferably at least 3 μg/g, even more preferably at least 4 μg/g, most preferably at least 5 μg/g of the antioxidant may be deposited onto the elastane-containing fabric, as measured according to the Deposition of

Antioxidant onto Fabric Test Method. Preferably, these levels of antioxidant remain on the elastane-containing fabric for at least 24 hours, preferably for at least 3 days, even more preferably for at least 7 days.

The method may further comprise the step of rinsing the elastane-containing fabric after the step of contacting the elastane-containing fabric with the fabric treatment composition in the presence of water. Rinsing the elastane-containing fabric may remove any residual materials deposited onto the elastane-containing fabric from the fabric treatment composition, such as surfactants. The step of rinsing the elastane-containing fabric may occur in any suitable vessel, such as, for example, a sink, or an automatic washing machine. The step of rinsing the elastane-containing fabric may occur as part of the rinse cycle of an automatic washing machine. The elastane-containing fabric may be rinsed using water, such as tap water or deionized water. Applicant has surprisingly found that for elastane-containing fabrics, an effective level of antioxidant will remain deposited onto the fabric surviving rinsing the fabric.

The method may further comprise the step of drying the elastane-containing fabric after the step of contacting the elastane-containing fabric with the fabric treatment composition in the presence of water. When the elastane-containing fabric is also rinsed, the step of drying the elastane-containing fabric may occur after the step of rinsing. The elastane-containing fabric may be air-dried or dried using a drying apparatus, such as an automatic drying machine.

In an aspect, the elastane-containing fabric may comprise an unsaturated organic soil prior to the step of contacting the elastane-containing fabric with the fabric treatment composition in the presence of water. The soils present on the elastane-containing fabric may enable attachment and reaction of the antioxidant with the soil. The unsaturated organic soil may be sebum.

In an aspect, the elastane-containing fabric may be substantially free of an unsaturated organic soil prior to the step of contacting the elastane-containing fabric with the fabric treatment composition in the presence of water. As Applicant has surprisingly found, although antioxidants such as those of the present disclosure generally do not deposit onto most fabrics, or deposit at very low levels onto most fabrics, antioxidants selectively deposit onto elastane-containing fabrics. Such deposition of antioxidants onto elastane-containing fabrics may then be effective in proactively retarding the formation of malodorous species when the fabric subsequently comes into contact with soils.

Although the antioxidant may deposit onto the elastane-containing fabric, the antioxidant will not be able to inhibit oxidation of the soils unless metal ions, such as copper ions, are present to initiate the autoxidation process of the soils. In an aspect, the treatment liquor may comprise at least 1 ppm of copper. The copper may be present in the treatment liquor from external water added to the fabric treatment composition or may come from the fabric treatment composition. In another aspect, the elastane-containing fabric may comprise at least 1 ppm of copper, prior to the step of contacting the elastane-containing fabric with the fabric treatment composition in the presence of water. Metal ions, such as copper, may be present in the soils. Generally, metal ions, such as copper, are present in sebum.

As Applicant has found, not all fabrics enable deposition of the antioxidant of the present disclosure. For effective deposition of the antioxidant, the elastane-containing fabric may comprise at least 1%, or at least 2%, or at least 3%, or at least 4%, or at least 5%, by weight of the elastane-containing fabric, of elastane. For fabrics comprising polyester, the elastane-containing fabric may comprise at least 4%, or at least 5%, by weight of the elastane-containing fabric, of elastane. For fabrics comprising nylon, the elastane-containing fabric may comprise at least 5%, or at least 10%, or at least 15%, or at least 20%, by weight of the elastane-containing fabric, of elastane. For fabrics comprising cotton, the elastane-containing fabric may comprise at least 5%, or at least 6%, or at least 7%, or at least 8%, by weight of the elastane-containing fabric, of elastane. For garments such as swimwear garments, the level of elastane in the fabric may be up to about 40%, by weight of the elastane-containing fabric, of elastane.

The elastane-containing fabric may comprise a material selected from the group consisting of polyester, nylon, cotton, and mixtures thereof. Polyester, nylon, and cotton, and mixtures thereof, are generally the most common materials incorporated with elastane.

In a non-limiting example, the elastane-containing fabric may comprise at least 50%, or at least 60%, or at least 70%, or at least 80%, or at least 90%, or at least 95%, by weight of the elastane-containing fabric, of polyester. Polyester is used extensively in garments and textiles as it is durable, resistant to shrinking, is strong yet lightweight, is quick drying, and is highly stain-resistant.

In another non-limiting example, the elastane-containing fabric may comprise at least 50%, or at least 60%, or at least 70%, or at least 80%, by weight of the elastane-containing fabric, of nylon. Nylon is used extensively in garments and textiles, particularly in garments used as athletic wear, as it is durable, strong, and flexible.

In yet another non-limiting example, the elastane-containing fabric may comprise at least 50%, or at least 60%, or at least 70%, or at least 80%, or at least 90%, or at least 92%, by weight of the elastane-containing fabric, of cotton. Cotton is used extensively in garments and textiles, particularly in garments used as athletic wear, as it is breathable, insulating, durable, and is advantageous in controlling moisture.

### III. Fabric Treatment Compositions

The present disclosure relates to fabric treatment compositions comprising an antioxidant. Such fabric treatment compositions and components thereof are described hereinafter.

Such fabric treatment compositions may include but are not limited to, laundry cleaning compositions and detergents, fabric softening compositions, fabric enhancing compositions, fabric freshening compositions, laundry prewash, laundry pretreat, laundry additives, spray products, dry cleaning agents or compositions, laundry rinse additives, wash additives, post-rinse fabric treatments, ironing aids, unit dose formulations, delayed delivery formulations, detergents contained on or in a porous substrate or nonwoven sheet, and other suitable forms that may be apparent to one skilled in the art in view of the teachings herein. Such fabric treatment compositions may be used as a pre-laundering treatment, a post-laundering treatment, or may be added during the rinse or wash cycle of the laundering operation, preferably during the wash cycle. Such treatment compositions may also be used in a dry-cleaning context.

The fabric treatment composition may be in any suitable form. The fabric treatment composition may be in a form selected from a liquid, solid, or a combination thereof. It is contemplated that the fabric treatment composition may be in the form of a solid composition suspended within a liquid.

The fabric treatment composition may be in the form of a liquid composition. The liquid composition may comprise from about 0% to about 99%, or from about 30% to about 90%, or from about 50% to about 80%, by weight of the composition, of water. The liquid composition may include non-aqueous liquid detergents.

The fabric treatment composition may be in the form of a solid composition. The solid composition may comprise from about 20% to about 98%, by weight of the composition, of a water-soluble carrier for forming solid compositions. In a non-limiting but preferred example, the water-soluble carrier for forming solid compositions may be polyethylene glycol. The polyethylene glycol carrier may have a weight average molecular weight of from about 2000 to about 20,000 Daltons, preferably from about 5000 to about 15,000 Daltons, more preferably from about 6000 to about 12,000 Daltons. The solid composition may comprise less than about 20%, preferably less than about 15%, more preferably less than about 5%, even more preferably less than about 1%, by weight of the composition, of water. In a preferred example, the fabric treatment composition is in the form of granules or particles. The granules and particles may have a shape selected from the group consisting of spherical, hemispherical, compressed hemispherical, lentil shaped, oblong, and mixtures thereof. One skilled in the art may recognize that these shapes are non-limiting and that the granules and particles may have any other shape known in the art for such granules and particles. The granules may have a maximum dimension (i.e. , length, width, height, diameter) of from about 0.1 mm to about 2 mm and a minimum dimension (i.e., length, width, height, diameter) of from about 0.05 mm to about 1.5 mm The particles may have a maximum dimension (i.e., length, width, height, diameter) of from about 2 mm to about 10 mm and a minimum dimension (i.e., length, width, height, diameter) of from about 1.5 mm to about 4 mm.

The fabric treatment composition may be free-flowing. Such free-flowing fabric treatment compositions may be packaged within a container such that a consumer may open the container and simply dose the amount of fabric treatment composition desired. The container may be any container known in the art suitable for containing fabric treatment compositions. For example, the container may have a volume of from about 50 cm³ to about 1500 cm³. The container may be of any suitable size and shape for placement on a grocery store shelf, for placement within a consumer's home, or for use within a commercial setting, such as a laundromat.

It is also contemplated that the fabric treatment composition may be incorporated into a unitized dose article, such as, for example, a single-compartment pouch, a multi-compartment pouch, a dissolvable sheet, a fibrous article, a tablet, a bar, or a mixture thereof. Such pouches typically include a water-soluble film, such as a polyvinyl alcohol water-soluble film, that at least partially encapsulates the fabric treatment composition. Suitable films include those commercially available from MonoSol, LLC, Indiana, United States. A multi-compartment pouch may comprise at least two, at least three, or at least four compartments. A multi-compartment pouch may include compartments that are side-by-side and/or superposed. The fabric treatment composition contained in the pouch or compartments thereof may be of liquid form, of solid form, or combinations thereof.

Fabric treatment compositions encapsulated within pouches may have relatively low amounts of water, for example less than about 20%, or less than about 15%, or less than about 12%, or less than about 10%, or less than about 8%, by weight of the fabric treatment composition, of water.

A. Antioxidant

The fabric treatment composition comprises an antioxidant. Antioxidants are substances as described in Kirk-Othmer (Vol. 3, page 424) and in Ullmann's Encyclopedia (Vol. 3, page 91). The fabric treatment composition comprises a level of antioxidant sufficient to provide at least 25 ppb, preferably at least 100 ppb, more preferably at least 250 ppb, even more preferably at least 500 ppb, even more preferably at least 1000 ppb, antioxidant concentration in the treatment liquor. The level of antioxidant may be from about 0.001% to about 50%, by weight of the fabric treatment composition.

The antioxidant may be selected from the group consisting of alkylated phenols, aryl amines, and mixtures thereof.

Alkylated phenols may have the general formula:

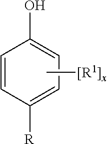

wherein R¹ is a C₃-C₆ branched alkyl, preferably tert-butyl; x is 1 or 2; and R is a C₁-C₂₂ linear alkyl or a C₃-C₂₂ branched alkyl, each (1) having optionally therein one or more ester (—CO₂—) or ether (—O—) links, and (2) optionally substituted by an organic group comprising an alkyleneoxy or polyalkyleneoxy group selected from EO, PO, BO, and mixtures thereof, more preferably from EO alone or from EO/PO mixtures; in an aspect R is preferably methyl or branched C₃-C₆ alkyl, C₁-C₆ alkoxy, preferably methoxy.

The alkylated phenol may be a hindered phenol. As used herein, the term “hindered phenol” is used to refer to a compound comprising a phenol group with either (a) at least one C₃ or higher branched alkyl, preferably a C₃-C₆ branched alkyl, preferably tert-butyl, attached at a position ortho to at least one phenolic —OH group, or (b) substituents independently selected from the group consisting of a C₁-C₆ alkoxy, preferably methoxy, a C₁-C₂₂ linear alkyl or C₃-C₂₂ branched alkyl, preferably methyl or branched C₃-C₆ alkyl, or mixtures thereof, at each position ortho to at least one phenolic —OH group. If a phenyl ring comprises more than one —OH group, the compound is a hindered phenol provided at least one such —OH group is substituted as described immediately above.

Suitable hindered phenols for use herein include, but are not limited to, 2,6-bis(1,1-dimethylethyl)-4-methyl-phenol (also known as hydroxy butylated toluene, “BHT”); 3,5-bis(1,1-dimethylethyl)-4-hydroxy-benzenepropanoic acid, methyl ester; 3,5-bis(1,1-dimethylethyl)-4-hydroxy-benzenepropanoic acid, octadecyl ester; δ-tocopherol; 2,6-bis(1-methylpropyl)phenol; 2-(1,1-dimethylethyl)-1,4-benzenediol; 2,4-bis(1,1-dimethylethyl)-phenol; 2,6-bis(1,1-dimethylethyl)-phenol; 2-(1,1-dimethylethyl)-4-methylphenol; 2-(1,1-dimethylethyl)-4,6-dimethyl-phenol; 3,5-bis(1,1-dimethylethyl)-4-hydroxybenzenepropanoic acid, 1,1′-[2,2-bis[[3-[3,5-bis(1,1-dimethylethyl)-4-hydroxyphenyl]-1-oxopropoxy]methyl]-1,3- propanediyl]ester; 2,2′-methylenebis[6-(1,1-dimethylethyl)-4-methylphenol; 2-(1,1-dimethylethyl)-phenol; 2,4,6-tris(1,1-dimethylethyl)-phenol; 4,4′-methylenebis [2,6-bis(1,1-dimethylethyl)-phenol; 4,4′4″-[(2,4,6-trimethyl-1,3,5-benzenetriyetris)tris(methylene)]tris[2,6-bis(1,1-dimethylethyl)-phenol]; N,N′-1,6-hexanediylbis[3,5-bis(1,1-dimethylethyl)-4-hydroxybenzenepropanamide; 3,5-bis(1,1-dimethylethyl)-4-hydroxybenzoic acid, hexadecyl ester; P-[[3,5-bis(1,1-dimethylethyl)-4-hydroxyphenyl]methylphosphonic acid, diethyl ester; 1,3,5-tris[[3,5-bis(1,1-dimethylethyl)-4-hydroxyphenyl]methyl]-1,3,5 -triazine-2,4,6(1H,3H,5H)-trione; 3,5-bis(1,1-dimethylethyl)-4-hydroxybenzenepropanoic acid, 2-[3-[3,5-bis(1,1-dimethylethyl)-4-hydroxyphenyl]-1-oxopropyl]hydrazide; 3-(1,1-dimethylethyl)-4-hydroxy-5 -methylbenzenepropanoic acid, 1,1′-[1,2-ethanediylbis(oxy-2,1-ethanediyl)]ester; 4-[(dimethylamino)methyl]-2,6-bis(1,1-dimethylethyl)phenol; 4-[[4,6-bis(octylthio)-1,3,5-triazin-2-yl]amino]-2,6-bis(1,1-dimethylethyl)phenol; 3,5-bis(1,1-dimethylethyl)-4-hydroxybenzenepropanoic acid, 1,1′-(thiodi-2,1-ethanediyl) ester; 3,5-bis(1,1-dimethylethyl)-4-hydroxybenzoic acid, 2,4-bis(1,1-dimethylethyl)phenyl ester; 3,5-bis(1,1-dimethylethyl)-4-hydroxybenzenepropanoic acid, 1,1′-(1,6-hexanediyl)ester; 3-(1,1-dimethylethyl)-4-hydroxy-5-methylbenzenepropanoic acid, 1,1′-[2,4,8,10-tetraoxaspiro[5.5]undecane-3,9-diylbis(2,2-dimethyl-2,1-ethanediyl)] ester; 3-(1,1-dimethylethyl)-β-[3-(1,1-dimethylethyl)-4-hydroxyphenyl]-4-hydroxy-β-methylbenzenepropanoic acid, 1,1′-(1,2-ethanediyl) ester; 2-[[3,5-bis(1,1-dimethylethyl)-4-hydroxyphenyl]methyl]-2-butylpropanedioic acid, 1,3-bis(1,2,2,6,6-pentamethyl-4-piperidinyl) ester; 3,5-bis(1,1-dimethylethyl)-4-hydroxybenzenepropanoic acid, 1-[2-[3-[3,5 -bis(1,1-dimethylethyl)-4-hydroxyphenyl]-1-oxopropoxy]ethyl]-2,2,6,6- tetramethyl-4-piperidinyl ester; 3,4-dihydro-2,5,7,8-tetramethyl-2-[(4R,8R)-4,8,12-trimethyltridecyl]-(2R)-2H-1-benzopyran-6-ol; 2,6-dimethylphenol; 2,3,5 -trimethyl-1,4-benzenediol; 2,4,6-trimethylphenol; 2,3,6-trimethylphenol; 4,4′-(1-methylethylidene)-bis[2,6-dimethylphenol]; 1,3,5-tris [[4-(1,1-dimethylethyl)-3-hydroxy-2,6-dimethylphenyl]methyl]-1,3,5-triazine-2,4,6(1H,3H,5H)-trione; 4,4′-methylenebis[2,6-dimethylphenol]; 2,6-bis(1-methylpropyl)phenol; and mixtures thereof.

Preferably, the hindered phenol is selected from the group consisting of 2,6-bis(1,1-dimethylethyl)-4-methyl-phenol; C₁-C₁₈ linear or branched alkyl esters of 3,5-bis(1,1-dimethylethyl)-4-hydroxy-benzenepropanoic acid; and mixtures thereof. Preferred examples of C₁-C₁₈ linear or branched alkyl esters of 3,5-bis(1,1-dimethylethyl)-4-hydroxy-benzenepropanoic acid include 3,5-bis(1,1-dimethylethyl)-4-hydroxy-benzenepropanoic acid, methyl ester (commercially available under the tradename RALOX® 35 from Raschig USA, Arlington, Tex., United States), and 3,5-bis(1,1-dimethylethyl)-4-hydroxy-benzenepropanoic acid, octadecyl ester (commercially available under the tradename TINOGARD® TS from BASF, Ludwigshafen, Germany).

In a preferred non-limiting example, the hindered phenol may be 2,6-bis(1,1-dimethylethyl)-4-methyl-phenol.

Additional phenolic antioxidants may be employed. Examples of suitable phenolic antioxidants may be selected from the group consisting of α-, β-, γ- tocopherol; 2,2,4-trimethyl-1,2-dihydroquinoline; tert-butyl hydroxyanisole; 6-hydroxy-2,5,7, 8-tetramethylchroman-2-carboxylic acid; and mixtures thereof.

An example of an aryl amine useful as an antioxidant of the present disclosure is ethoxyquin (e.g., 1,2-dihydro-6-ethoxy-2,2,4-trimethylquinoline, commercially available under the tradename RALUQUIN™, from Raschig USA, Arlington, Tex., United States). The aryl amine may be a diarylamine Diarylamines that are useful in this invention can be represented by the general formula

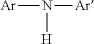

wherein Ar and Ar′ are each independently selected from aromatic aryl radicals and heteroaromatic aryl radicals, wherein at least one aryl radical is substituted. Suitable diarylamines may include, but are not limited to, 4-(1,1,3,3-tetramethylbutyl)-N-[4-(1,1,3,3-tetramethylbutyl)phenyl]-benzenamine (commercially available under the tradename IRGANOX® 5057 from BASF, Ludwigshafen, Germany) and 4-(1-methyl-1-phenylethyl)-N-[4-(1-methyl-1-phenylethyl)phenyl]-benzenamine (commercially available under the tradename NAUGARD® 445 from Addivant, Danbury, Conn., United States).

B. Surfactant

The fabric treatment composition may comprise from about 0.1% to about 80%, by weight of the fabric treatment composition, of a surfactant. The surfactant may be selected from the group consisting of nonionic surfactants, anionic surfactants, amphoteric surfactants, zwitterionic surfactants, cationic surfactants, and mixtures thereof. Anionic and nonionic surfactants are typically employed if the fabric treatment composition is a laundry cleaning composition or detergent. Cationic surfactants are typically employed if the fabric treatment composition is a fabric softening composition. Surfactants may provide soil removal and assist in dispersing the antioxidant, while not negatively impacting the deposition of the antioxidant onto the elastane-containing fabric.

Suitable nonionic surfactants may include, but are not limited to, alkoxylated fatty alcohols (e.g., ethoxylated fatty alcohols); alkoxylated alkyl phenols; alkyl phenol condensates; mid-chain branched alcohols; mid-chain branched alkyl alkoxylates; alkylpolysaccharides; polyhydroxy fatty acid amides; ether capped poly(oxyalkylated) alcohol surfactants; and mixtures thereof. The alkoxylate units may be ethyleneoxy units, propyleneoxy units, or mixtures thereof. The nonionic surfactant may be linear, branched (e.g., mid-chain branched), or a combination thereof. Examples of suitable nonionic surfactants may include those commercially available under the tradename PLURONIC® from BASF, Ludwigshafen, Germany, those commercially available under the tradename NEODOL® nonionic from Shell, The Hague, The Netherlands, and those commercially available under the tradename SURFONIC® from Huntsman Corporation, The Woodlands, Tex., United States.

Suitable anionic surfactants may include, but are not limited to sulfate detersive surfactants (e.g., alkoxylated and/or non-alkoxylated alkyl sulfate materials); and/or sulfonic detersive surfactants (e.g., alkyl benzene sulfonates). The anionic surfactant may be linear, branched, or combinations thereof. Preferred anionic surfactants may include, but are not limited to, linear alkyl benzene sulfonate (LAS), alkyl ethoxylated sulfate (AES), alkyl sulfates (AS), and mixtures thereof. Other suitable anionic surfactants may include branched modified alkyl benzene sulfonates (MLAS), methyl ester sulfonates (MES), and/or alkyl ethoxylated carboxylates (AEC). The anionic surfactants may be present in acid form, salt form, or mixtures thereof. The anionic surfactant may be neutralized, in part or in whole, for example, by an alkali metal (e.g., sodium) or an amine (e.g., monoethanolamine). The anionic surfactant may be pre-neutralized, preferably with an alkali metal, an alkali earth metal, an amine such as an ethanolamine, or mixtures thereof.

Suitable amphoteric surfactants may include any conventional amphoteric surfactant known to one skilled in the art, such as amine oxides. Preferred amine oxides may include alkyl dimethyl amine oxide or alkyl amido propyl dimethyl amine oxide, more preferably alkyl dimethyl amine oxide and even more preferably coco dimethyl amino oxide. The amine oxide may have a linear or mid-branched alkyl moiety. Typical linear amine oxides may include water-soluble amine oxides containing one R₁ C₈₋₁₈ alkyl moiety and two R₂ and R₃ moieties selected from the group consisting of C₁₋₃ alkyl groups, C₁₋₃ hydroxyalkyl groups, and mixtures thereof. Preferably, the amine oxide is characterized by the formula R₁-N(R₂)(R₃) O wherein R₁ is a C₈₋₁₈ alkyl and R₂ and R₃ are selected from the group consisting of methyl, ethyl, propyl, isopropyl, 2-hydroxyethyl, 2-hydroxypropyl and 3-hydroxypropyl. The amine oxide surfactant may include linear C₁₀-C₁₈ alkyl dimethyl amine oxides and linear C₈-C₁₂ alkoxy ethyl dihydroxy ethyl amine oxides.

Suitable zwitterionic surfactants may include any conventional zwitterionic surfactant known to one skilled in the art, such as betaines, particularly alkyl betaine, alkylamidobetaine, amidazoliniumbetaine, sulfobetaine, hydroxybetaines, and phosphobetaines. Examples of suitable betaines may include alkyl dimethyl betaine and cocodimethyl amidopropyl betaine, N-alkyl-N,N-dimethylammino-1-propane sulfonate where the alkyl group can be C₈ to C₁₈, or from C₈ to C₁₄.

Suitable cationic surfactants may include, but are not limited to, alkyl pyridinium compounds, alkyl quaternary ammonium compounds, alkyl quaternary phosphonium compounds, alkyl ternary sulphonium compounds, and mixtures thereof. Preferred cationic surfactants are quaternary ammonium compounds having the general formula: (R)(R₁)(R₂)(R₃)N⁺ X⁻ wherein, R is a linear or branched, substituted or unsubstituted C₆₋₁₈ alkyl or alkenyl moiety, R₁ and R₂ are independently selected from methyl or ethyl moieties, R₃ is a hydroxyl, hydroxymethyl or a hydroxyethyl moiety, X is an anion which provides charge neutrality, preferred anions include: halides, preferably chloride; sulphate; and sulphonate. For the purposes of the present invention, cationic surfactants include those which can deliver fabric care benefits. Non-limiting examples of useful cationic surfactants include: fatty amines, imidazoline quat materials and quaternary ammonium surfactants, preferably N, N-bis(stearoyl-oxy-ethyl) N,N-dimethyl ammonium chloride, N,N-bis(tallowoyl-oxy-ethyl) N,N-dimethyl ammonium chloride, N,N-bis(stearoyl-oxy-ethyl) N-(2 hydroxyethyl) N-methyl ammonium methylsulfate; 1,2 di (stearoyl-oxy) 3 trimethyl ammoniumpropane chloride; dialkylenedimethylammonium salts such as dicanoladimethylammonium chloride, di(hard)tallowdimethylammonium chloride dicanoladimethylammonium methylsulfate; 1-methyl-1-stearoylamidoethyl-2-stearoylimidazolinium methylsulfate; 1-tallowylamidoethyl-2-tallowylimidazoline; N,N″-dialkyldiethylenetriamine; the reaction product of N-(2-hydroxyethyl)-1,2-ethylenediamine or N-(2-hydroxyisopropyl)-1,2-ethylenediamine with glycolic acid, esterified with fatty acid, where the fatty acid is (hydrogenated) tallow fatty acid, palm fatty acid, hydrogenated palm fatty acid, oleic acid, rapeseed fatty acid, hydrogenated rapeseed fatty acid, and a mixture of the above.

C. Adjunct Ingredients

The fabric treatment composition of the present disclosure may include additional adjunct ingredients. Such adjunct ingredients may provide additional treatment benefits to the treated fabrics, and/or they may act as stabilization or processing aids to the fabric treatment composition. The fabric treatment composition may comprise an adjunct ingredient selected from the group consisting of chelants, perfumes, structurants, chlorine scavengers, solvents, fabric conditioning actives, and mixtures thereof.
i. Chelants

The fabric treatment composition may comprise from about 0.1% to about 10%, by weight of the fabric treatment composition, of a chelant. Chelants may provide additional malodor control benefits. Suitable chelants may include, but are not limited to, ethylenediaminetetracetates, N-(hydroxyethyl)-ethylene-diamine-triacetates, nitrilotriacetates, ethylenediamine tetraproprionates, triethylene-tetraamine-hexacetates, diethylenetriamine-pentaacetates, ethanoldiglycines, ethylenediaminetetrakis (methylenephosphonates), diethylenetriamine penta(methylene phosphonic acid) (DTPMP), ethylenediamine disuccinate (EDDS), hydroxyethanedimethylenephosphonic acid (HEDP), methylglycinediacetic acid (MGDA), diethylenetriaminepentaacetic acid (DTPA), and 1,2-diydroxybenzene-3,5-disulfonic acid (Tiron), salts thereof, and mixtures thereof. Other non-limiting examples of suitable chelants can be found in U.S. Pat. Nos. 7,445,644, 7,585,376 and 2009/0176684 A1 (all to The Procter & Gamble Company, Cincinnati, Ohio, United States). Examples of suitable chelants include those commercially available under the tradename DEQUEST® series from Italmatch Chemicals, Genoa, Italy, and chelants commercially available from Monsanto, St. Louis, Mo., United States, DuPont Chemical, Wilmington, Del., United States, and Nalco Inc., Naperville, Ill., United States.
ii. Perfumes

The fabric treatment composition may comprise from about 0.1% to about 20%, by weight of the fabric treatment composition, of a perfume. Perfumes may impart a scent benefit on fabrics treated with the fabric treatment composition. The perfume may be an unencapsulated perfume, an encapsulated perfume, or a perfume provided by another perfume delivery technology. Perfumes are generally described in U.S. Pat. No. 7,186,680 (issued to The Procter & Gamble Company, Cincinnati, Ohio, United States). Encapsulated perfume can be provided as plurality of perfume microcapsules, which comprise a perfume oil enclosed within a shell. The perfume microcapsules can be friable perfume microcapsules. Perfume microcapsules can be those described in U.S. Patent Pub. 2008/0305982 (to The Procter & Gamble Company, Cincinnati, Ohio, United States). Encapsulated perfumes may be beneficial in fabric treatment compositions of the present disclosure as they may enhance the sensorial experience of the consumer particularly when combined with reduction in malodor brought on by the antioxidants.

The fabric treatment composition can be substantially free of a perfume, for instance, when perfume-free fabric treatment compositions are desired for consumers sensitive to perfumes or not wanting perfumes to treat their fabrics.

In some cases, it may be desirable for the fabric treatment composition to be relatively unscented. In such cases, no additional perfume is added, and the fabric treatment composition may be substantially free of a perfume.
iii. Structurants

The fabric treatment composition, particularly when the fabric treatment composition is in liquid form, may comprise from about 0.1% to about 10%, by weight of the fabric treatment composition, of a structurant. Structurants can provide physical stability to liquid compositions. Suitable structurants may include, but are not limited to, non-polymeric crystalline hydroxy-functional structurants, and/or polymeric structurants.

Non-polymeric crystalline hydroxy-functional structurants may comprise a crystallizable glyceride, which may be pre-emulsified to aid dispersion into the final fabric treatment composition. Suitable crystallizable glycerides may include but are not limited to, hydrogenated castor oil (“HCO”) or derivatives thereof, provided that it is capable of crystallizing in the liquid fabric treatment composition.

Polymeric structurants may include naturally derived structurants and/or synthetic structurants. Naturally derived polymeric structurants may include, but are not limited to, hydroxyethyl celluloses, hydrophobically modified hydroxyethyl celluloses, carboxymethyl celluloses, polysaccharide derivatives, and mixtures thereof. Suitable polysaccharide derivatives may include, but are not limited to, pectine, alginate, arabinogalactan, carrageenan, gellan gum, xanthan gum, guar gum, and mixtures thereof. Synthetic polymeric structurants may include, but are not limited to, polycarboxylates, polyacrylates, hydrophobically modified ethoxylated urethanes, hydrophobically modified non-ionic polyols, and mixtures thereof
iv. Chlorine Scavengers

The fabric treatment composition may comprise from about 0.1% to about 10%, by weight of the fabric treatment composition, of a chlorine scavenger. Chlorine may be present in the water provided to form the treatment liquor and resulting hypochloride ions may degrade elastane fibers. Suitable chlorine scavengers may include, but are not limited to, ammonium chloride, primary amines (such as monoethanolamine), and other chlorine scavengers known to those of ordinary skill in the art.
v. Solvents

The fabric treatment composition may comprise from about 0.1% to about 40%, by weight of the fabric treatment composition, of a solvent. Solvents may act as a carrier and/or facilitate stability of the fabric treatment composition, particularly when in liquid form. Non-aqueous solvents may include organic solvents, such as methanol, ethanol, propanol, isopropanol, 1,3-propanediol, 1,2-propanediol, ethylene glycol, glycerine, glycol ethers, hydrocarbons, and mixtures thereof. Other non-aqueous solvents may include lipophilic fluids such as siloxanes or other silicones, hydrocarbons, perfluorinated amines, perfluorinated and hydrofluoroether solvents, and mixtures thereof.
vi. Fabric Conditioning Active

The fabric treatment composition may comprise from about 1% to about 30%, by weight of the fabric treatment composition, of a fabric conditioning active. Fabric conditioning actives may be useful in providing softness, anti-wrinkle, conditioning, anti-stretch, color, and/or appearance benefits to the treated fabrics. Suitable fabric conditioning actives may include, but are not limited to, quaternary ammonium ester compounds, silicones, non-ester quaternary ammonium compounds, amines, fatty esters, sucrose esters, silicones, dispersible polyolefins, polysaccharides, fatty acids, softening or conditioning oils, polymer latexes, and mixtures thereof. Non-limiting examples of suitable quaternary ammonium ester compounds are those commercially available under the tradenames REWOQUAT® WE18 and REWOQUAT® WE 20 from Evonik, Essen, Germany, and those commercially available under the tradenames STEPANTEX® GA90, STEPANTEX® VK90, and STEPANTEX® VL90A from Stepan Company, Northfield, Ill., United States.

IV. Methods: Deposition of Antioxidant onto Fabric Test Method

A. Preparation of Fabric Swatches Method

Stripped 4″×4″ fabric swatches are prepared for testing by washing the fabric four times (two cycles with 1.55 g/L of standard fabric treatment detergent without brightener; followed by two cycles with only water and no detergent, all in a standard washing machine set to Heavy Duty Cycle at approximately 49° C.). The fabrics are then dried using a standard dryer set to Permanent Press.

B. Contacting Fabric with a Fabric Treatment Composition

Stripped test fabric swatches are prepared according to the Preparation of Fabric Swatches Method. The test fabric swatches are weighed together and placed in a 500 mL Erlenmeyer flask along with one 10 mm glass marble per each fabric swatch. An aliquot of fabric treatment composition to be tested is added to the Erlenmeyer flask in an amount sufficient to provide a 25:1 treatment liquor to fabric (w/w) ratio. The Erlenmeyer flask is dosed with a 1000 gpg stock hardness solution to achieve a final treatment liquor hardness of 6 gpg (3:1 calcium: magnesium).

The Erlenmeyer flask is placed on a standard laboratory shaker and agitated at the maximum setting for 12 minutes, after which the treatment liquor is removed by aspiration. A volume of rinse water (0 gpg) equivalent to the amount of treatment liquor removed is added to the Erlenmeyer flask. The Erlenmeyer flask is dosed with a 1000 gpg stock hardness solution to achieve a final rinse liquor hardness of 6 gpg (3:1 calcium: magnesium) before agitating at the maximum setting for 4 more minutes. The rinse liquor is removed by aspiration.

The test fabric swatches are then spun dry for 1 minute using a standard spin dryer, then placed in a food dehydrator set to 50° C. for 30 minutes. Using a metal cutting die and a hydraulic press, test circles measuring 25 mm in diameter are then cut from the test fabric swatches and placed in Mylar bags.

A calibration curve is determined for the antioxidant used at known concentrations using an HPLC machine set to an ultraviolet (UV) wavelength according to the chosen antioxidant. The test fabric swatches are vortexed with an extraction buffer (90/10 acetonitrile/water; approximately a 1:8 w/w ratio between test fabric swatches and extraction buffer) at room temperature (˜23° C.) for two hours to extract the deposited antioxidant from each of the test fabric swatches, forming extracted antioxidant solutions. An aliquot of each extracted antioxidant solution is added to separate HPLC vials. A blank solvent (70/30 acetonitrile/water) is added to the extracted antioxidant solutions to form diluted extracted antioxidant solutions to fit the calibration curve. The diluted extracted antioxidant solutions are then measured and quantified against the antioxidant calibration curve previously described. The measurement output of antioxidant deposition on fabric is given in μg of antioxidant/g diluted extracted antioxidant solution in the HPLC vial. To convert to μg of antioxidant/g of fabric, the following calculation is made:

$$\frac{µg antioxidant}{g fabric} = \frac{µg antioxidant}{\begin{matrix}g diluted extracted \\ antioxidant solution\end{matrix}} * \frac{\begin{matrix}g diluted extracted \\ antioxidant solution\end{matrix}}{\frac{ g aliquot of extracted}{antioxidant solution}} * \frac{g extraction buffer}{g fabric}$$

### V.

### EXAMPLES

### Example 1

### Deposition of Antioxidant onto Various Fabrics Containing Elastane and Without Elastane

To evaluate the deposition of antioxidant onto various fabrics, six fabric swatches (Examples 1A, 1B, 2A, 2B, 3A, 3C) were prepared according to the Preparation of Fabric Swatches Method and Deposition of Antioxidant onto Fabric Test Method under the following conditions: 1.55 g/L AATCC Standard Reference High Efficiency Liquid Detergent without brightener, Item #48805A, obtained from AATCC Research Triangle Park, N.C., United States; washing machine: Kenmore 600 Series washing machine; dryer: Maytag Commercial Dryer; a fabric treatment composition having 0.1% antioxidant prepared by dissolving 2 g of antioxidant in 18 g of non-ionic surfactant to form a 10% antioxidant solution and then adding 1 g of the 10% antioxidant solution to 99 g of the AATCC Standard Reference High Efficiency Detergent without brightener to form the fabric treatment composition having 0.1% antioxidant (the fabric treatment composition having 0.1% antioxidant is then added to deionized water at 1.55 g/1.0 L. This dosage provides an antioxidant level of 1.55 ppm (1550 ppb) through the wash); antioxidant selected is butylated hydroxytoluene; non-ionic surfactant is commercially available under the tradename SURFONIC® L24-9 from Huntsman Corporation, The Woodlands, Tex., United States; laboratory shaker: Burrell Scientific Wrist Action™ Model 75 commercially available from Burrell Scientific, Pittsburgh, Pa., United States; spin dryer: Mini Countertop Spin Dryer commercially available from The Laundry Alternative, Inc., Nashua, N.H., United States; food dehydrator: Nesco American Harvest food dehydrator model FD-80 commercially available from Nesco, Inc., Two Rivers, Wis., United States; HPLC machine: Agilent 1260 Infinity Quaternary HPLC machine commercially available from Agilent, Santa Clara, Calif., United States; ultraviolet (UV) wavelength setting: 278 nm; aliquot of extracted antioxidant solution added to HPLC vial: 1 mL; blank solvent added to extracted antioxidant solution to form diluted extracted antioxidant solutions: 0.2 mL blank solvent.

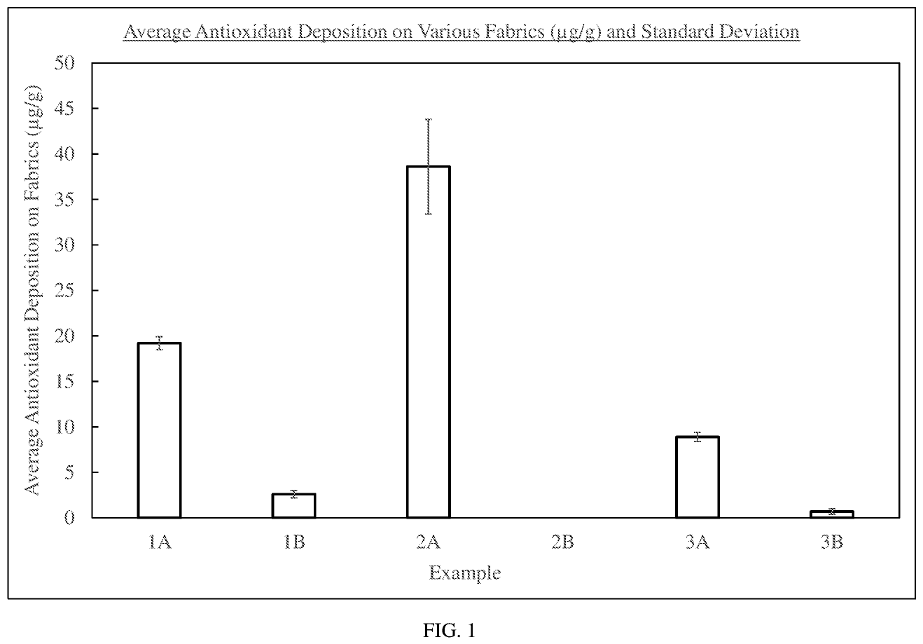

Each experiment is run in triplicate to obtain an average and standard deviation. The results are in Table 1, below and in FIG. 1.

TABLE 1
Deposition of Antioxidant onto Various Fabrics

| | | | Average | |
|---|---|---|---|---|
| | | | Antioxidant | |
| | | | Deposition | |
| | | Fabric | on Fabric | Standard |
| Example | Fabric Type | Composition | (μg/g) | Deviation |
| 1A | Nylon/elastane¹ | 80% nylon/ | 19.2 | 0.7 |
| | | 20% elastane | | |
| 1B | Nylon² | 100% nylon | 2.6 | 0.4 |
| 2A | Polyester/ | 95% polyester/ | 38.6 | 5.2 |
| | elastane³ | 5% elastane | | |
| 2B | Polyester⁴ | 100% polyester | 0 | 0 |
| 3A | Cotton/elastane⁵ | 92% cotton/ | 8.9 | 0.5 |
| | | 8% elastane | | |
| 3C | Cotton⁶ | 100% cotton | 0.7 | 0.3 |

¹Nylon/elastane fabric (style NS, code #19505, commercially available from WFL America, LLC, Rock Hill, South Carolina, United States).
²Nylon fabric (style #365, commercially available from Testafabrics, West Pittston, Pennsylvania, United States).
³Polyester/elastane fabric (style PS, code #19507, commercially available from WFL America, LLC, Rock Hill, South Carolina, United States).
⁴Polyester fabric (style PE, code #19508, commercially available from WFL America, LLC, Rock Hill, South Carolina, United States).
⁵Cotton/elastane fabric (style #4301, commercially available from Testafabrics, West Pittston, Pennsylvania, United States).
⁶Cotton fabric (style #403, commercially available from Testafabrics, West Pittston, Pennsylvania, United States).

As shown by the results in Table 1 and FIG. 1, each of the three fabrics comprising elastane have improved antioxidant deposition over their respective non-elastane containing counterparts. As illustrated by Examples 2A and 2B, when elastane is not present in the fabric (Example 2B), there is no deposition of antioxidant onto the fabric. When elastane is present (Example 2A), even at low levels, there is a high deposition level of antioxidant onto the fabric, illustrating that it is the elastane in the fabric that enables deposition of the antioxidant.

### Example 2

### Reduction of Malodor from Fabric on which Antioxidant is Deposited

This example demonstrates the malodor reduction benefits that can result when an elastane-containing fabric comprising added antioxidant, deposited in an aqueous wash solution with a composition comprising an antioxidant, is exposed to autoxidizable soil. The malodor reduction benefits are manifest when the elastane-containing fabric is soiled with an autoxidizable soil.

A. Preparation of Fabric Swatches

Swatches of fabric (2″×2″; Style #4301, 92% cotton/8% elastane, obtained from Testafabrics, West Pittston, Pa.) are prepared for testing by washing the fabric four times (two cycles with 1.55 g/L of standard AATCC heavy duty liquid detergent without brightener; followed by two cycles with only water and no detergent, all in a standard washing machine set to Heavy Duty Cycle at approximately 49° C.). The fabrics are contained within mesh garment lingerie laundry bag and dried using a standard dryer set to Permanent Press.

B. Deposition of Copper (II) on Fabric

A stock solution of Cu²⁺ in deionized water is prepared using copper chloride dihydrate salt (Alfa Aesar, Haverhill, Mass.). Cotton/elastane swatches are placed on drying racks, individually dosed with copper solution to achieve 10 μg Cu²⁺ per gram of fabric, then dried in a food dehydrator (50° C. for 30 minutes).

C. Preparation of Body Soil Composition

Artificial body soil (ABS) and squalene (CAS # 111-02-4) are dissolved in dipropylene glycol monomethyl ether (DPGM; CAS # 34590-94-8) in a 100 mL glass jar with Teflon lined cap. ABS (Accurate Product Development, Fairfield, Ohio 45014) is melted at 40° C. before addition to the jar. The body soil composition contains 8 wt % each of ABS and squalene.

D. Preparation of Soiled Test Fabrics (STF)

To simulate post-wash soiling, cotton/elastane fabrics containing 0.45 μmol antioxidant/g of fabric are prepared by applying 90 μl of the body soil composition prepared in step C. above. Three different antioxidants (see Table A) were tested along with a nil-antioxidant control fabric. The swatches are dried in food dehydrator set to 50° C. for 10 minutes. Individual swatches are placed in 10 ml glass headspace vials and lids with Teflon™ septum (Restek; Bellefonte, Pa.) are crimped in place.

E. Analytical Detection of Malodor on Soiled Test Fabric

The malodor reduction using ABS/Squalene malodor sensors are quantitatively determined by Gas Chromatography Mass Spectroscopy using an Agilent gas chromatograph 7890B equipped with a mass selective detector (5977B), a Chemstation quantitation package and a Gerstel multi-purpose sampler equipped with a solid phase micro-extraction (SPME) probe. Calibration standards of 6-methyl-5-hepten-2-one (CAS 110-93-0), trans-2-heptenal (18829-55-5) and 3-methyl-2-butenal (107-86-8) are prepared by dissolving a known weight of these materials in light mineral oil (CAS 8020-83-5) (each material available from Sigma Aldrich). Vials are equilibrated greater than 4 hours before analysis. The following settings are used in the auto sampler: 80° C. incubation temperature, 90 min incubation time, VT32-10 sample tray type, 22 mm vial penetration, 20 min extraction time, 54 mm injection penetration and 300 s desorption time. The following settings are used for the Front Split/Splitless inlet helium: split mode, 250° C. temperature, 12 psi pressure, 79.5 mL/min total flow, 3 mL/min septum purge flow, 50:1 split ratio and 22.5 min GC run time. The follow settings are used in the oven: 40° C. initial temperature, 12C/min heating program, 250° C. temperature and 5 min hold time. Based on the partition coefficients (K at 80° C.) of each component, the total nmol/liter of 6-methyl-5-hepten-2-one (K=3353), trans-2-heptenal (K=3434), and 3-methyl-2-butenal (K=1119) are calculated. The values of these three measurements (in nmoles/L) are added together to provide the Total ABS/Squalene Markers (nmoles/L) for a given test leg.

F. Calculation of % Oxidation Products Remaining

The % Oxidation Products Remaining (% OPR) is provided as a percentage comparing the amount of selected malodor markers detected as provided by the antioxidant treated fabrics compared to the (nil-antioxidant) reference fabrics. The value is determined as follows:
% Oxidation Products Remaining =(Markersₜₑₛₜ/Markers_{ref})*100
Values for Markersref and Markerstest are defined as follows:
   Markers_{ref}=Total ABS/Squalene Markers (nmoles/L) of the fabrics dosed with the formulation without antioxidant (e.g., the reference or control formulation)
   Markersₜₑₛₜ=Total ABS/Squalene Markers (nmoles/L) of the fabrics dosed with the formulation with the tested antioxidant

G. Results

The results of the experiments described above are shown in Table A. All the fabrics comprising additional antioxidant (whether diarylamine or hindered phenol) have significantly lower % OPR than the control fabric.

TABLE A
% Oxidation Products Remaining on Soiled Test Fabrics

| | Antioxidant | | |
|---|---|---|---|
| Treatment | ID | Type | % OPR |
| A | No Antioxidant | N/A | 100 |
| B | 4-(1-methyl-1-phenylethyl)-N-[4-(1- | Diarylamine | 57.6 |
| | methyl-1-phenylethyl)phenyl]benzenamine | | |
| C | 2,6-bis(1,1-dimethylethyl)-4-methyl-phenol | Hindered Phenol | 24.1 |
| D | 3,5-bis(1,1-dimethylethyl)-4-hydroxy- | Hindered Phenol | 33.4 |
| | benzenepropanoic acid, methyl ester | Ester | |

As the measured oxidation products are typically considered malodorous, it is believed that the lower the % OPR provided by a composition, the less malodorous the treated fabrics are likely to be. Therefore, lesser values of % OPR are typically preferred. The compositions and processes of the present disclosure may provide a % OPR value of less than about 90%, or less than about 80%, or less than about 70%, or less than about 60%, or less than about 50%, or less than about 40%, or less than about 30%, or less than about 20%.

### VI. Combinations

A. A method of treating an elastane-containing fabric, comprising the steps of:
providing a fabric treatment composition comprising an antioxidant and a surfactant; providing an elastane-containing fabric; and
contacting the elastane-containing fabric with the fabric treatment composition in the presence of water, wherein the fabric treatment composition and the water form a treatment liquor having an antioxidant concentration of at least 25 ppb, preferably at least 100 ppb, more preferably at least 250 ppb, even more preferably at least 500 ppb, even more preferably at least 1000 ppb, a surfactant concentration of at least 10 ppm, preferably at least 25 ppm, more preferably at least 50 ppm, even more preferably at least 100 ppm, and wherein the ratio of treatment liquor to elastane-containing fabric (w/w) is from 0.1:1 to 100:1;
wherein at least some portion, preferably at least 1 μg/g, more preferably at least 2 μg/g, more preferably at least 3 μg/g, even more preferably at least 4 μg/g, most preferably at least 5 μg/g, of the antioxidant is deposited onto the elastane-containing fabric as measured according to the Deposition of Antioxidant onto Fabric Test Method.
   B. The method of treating an elastane-containing fabric according to Paragraph A, wherein the method further comprises the step of rinsing the elastane-containing fabric after the step of contacting the elastane-containing fabric with the fabric treatment composition in the presence of water.
   C. The method of treating an elastane-containing fabric according to any one of Paragraphs A or B, wherein the method further comprises the step of drying the elastane-containing fabric after the step of contacting the elastane-containing fabric with the fabric treatment composition in the presence of water.
   D. The method of treating an elastane-containing fabric according to any one of Paragraphs A to C, wherein the elastane-containing fabric comprises an unsaturated organic soil prior to the step of contacting the elastane-containing fabric with the fabric treatment composition in the presence of water, preferably wherein the unsaturated organic soil comprises sebum.
   E. The method of treating an elastane-containing fabric according to any one of Paragraphs A to C, wherein the elastane-containing fabric is substantially free of an unsaturated organic soil prior to the step of contacting the elastane-containing fabric with the fabric treatment composition in the presence of water.
   F. The method of treating an elastane-containing fabric according to any one of Paragraphs A to E, wherein the treatment liquor comprises at least 1 ppm of copper.
   G. The method of treating an elastane-containing fabric according to any one of Paragraphs A to F, wherein the elastane-containing fabric comprises at least 1 ppm of copper prior to the step of contacting the elastane-containing fabric with the fabric treatment composition in the presence of water.
   H. The method of treating an elastane-containing fabric according to any one of Paragraphs A to G, wherein the elastane-containing fabric comprises at least 1%, or at least 2% or at least 3%, or at least 4%, or at least 5%, by weight of the elastane-containing fabric, of elastane.
   I. The method of treating an elastane-containing fabric according to any one of Paragraphs A to H, wherein the elastane-containing fabric comprises a material selected from the group consisting of polyester, nylon, cotton, and mixtures thereof.
   J. The method of treating an elastane-containing fabric according to Paragraph I, wherein the elastane-containing fabric comprises at least 50%, or at least 60%, or at least 70%, or at least 80%, or at least 90%, by weight of the elastane-containing fabric, of polyester.
   K. The method of treating an elastane-containing fabric according to Paragraph I, wherein the elastane-containing fabric comprises at least 50%, or at least 60%, or at least 70%, or at least 80%, by weight of the elastane-containing fabric, of nylon.
   L. The method of treating an elastane-containing fabric according to Paragraph I, wherein the elastane-containing fabric comprises at least 50%, or at least 60%, or at least 70%, or at least 80%, or at least 90%, or at least 92%, by weight of the elastane-containing fabric, of cotton.
   M. The method of treating an elastane-containing fabric according to any one of Paragraphs A to L, wherein the antioxidant is selected from the group consisting of alkylated phenols, aryl amines, and mixtures thereof, preferably the alkylated phenol is a hindered phenol selected from the group consisting of 2,6-bis(1,1-dimethylethyl)-4-methyl-phenol; C₁-C₁₈ linear or branched alkyl esters of 3,5-bis(1,1-dimethylethyl)-4-hydroxy-benzenepropanoic acid; and mixtures thereof, preferably the hindered phenol is 2,6-bis(1,1-dimethylethyl)-4-methyl-phenol.
   N. The method of treating an elastane-containing fabric according to any one of Paragraphs A to M, wherein the surfactant comprises anionic surfactant, nonionic surfactant, or combinations thereof.
   O. The method of treating an elastane-containing fabric according to any one of Paragraphs A to M, wherein the fabric treatment composition comprises an adjunct ingredient selected from the group consisting of chelants, perfumes, structurants, chlorine scavengers, solvents, fabric conditioning actives, and mixtures thereof, preferably wherein the adjunct ingredient is a surfactant and/or a chelant.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of treating an elastane-containing fabric, comprising the steps of:
a) providing a fabric treatment composition comprising an antioxidant and a surfactant;
b) providing an elastane-containing fabric; and
c) contacting the elastane-containing fabric with the fabric treatment composition in the presence of water,
wherein the fabric treatment composition and the water form a treatment liquor having an antioxidant concentration of at least 25 ppb, a surfactant concentration of at least 10 ppm, and wherein the ratio of treatment liquor to elastane-containing fabric (w/w) is from 0.1:1 to 100:1;
wherein at least some portion of the antioxidant is deposited onto the elastane-containing fabric.

2. The method of treating an elastane-containing fabric according to claim 1, wherein the method further comprises the step of rinsing the elastane-containing fabric after the step of contacting the elastane-containing fabric with the fabric treatment composition in the presence of water.

3. The method of treating an elastane-containing fabric according to claim 1, wherein the method further comprises the step of drying the elastane-containing fabric after the step of contacting the elastane-containing fabric with the fabric treatment composition in the presence of water.

4. The method of treating an elastane-containing fabric according to claim 1, wherein the elastane-containing fabric comprises an unsaturated organic soil prior to the step of contacting the elastane-containing fabric with the fabric treatment composition in the presence of water.

5. The method of treating an elastane-containing fabric according to claim 4, wherein the unsaturated organic soil comprises sebum.

6. The method of treating an elastane-containing fabric according to claim 1, wherein the elastane-containing fabric is substantially free of an unsaturated organic soil prior to the step of contacting the elastane-containing fabric with the fabric treatment composition in the presence of water.

7. The method of treating an elastane-containing fabric according to claim 1, wherein at least 1 μg/g of the antioxidant is deposited onto the elastane-containing fabric, as measured according to the Deposition of Antioxidant onto Fabric Test Method.

8. The method of treating an elastane-containing fabric according to claim 1, wherein the treatment liquor comprises at least 1 ppm of copper.

9. The method of treating an elastane-containing fabric according to claim 1, wherein the elastane-containing fabric comprises at least 1 ppm of copper prior to the step of contacting the elastane-containing fabric with the fabric treatment composition in the presence of water

10. The method of treating an elastane-containing fabric according to claim 1, wherein the elastane-containing fabric comprises at least 1%, by weight of the elastane-containing fabric, of elastane.

11. The method of treating an elastane-containing fabric according to claim 1, wherein the elastane-containing fabric comprises a material selected from the group consisting of polyester, nylon, cotton, and mixtures thereof.

12. The method of treating an elastane-containing fabric according to claim 11, wherein the elastane-containing fabric comprises at least 50%, by weight of the elastane-containing fabric, of polyester.

13. The method of treating an elastane-containing fabric according to claim 11, wherein the elastane-containing fabric comprises at least 50%, by weight of the elastane-containing fabric, of nylon.

14. The method of treating an elastane-containing fabric according to claim 11, wherein the elastane-containing fabric comprises at least 50%, by weight of the elastane-containing fabric, of cotton.

15. The method of treating an elastane-containing fabric according to claim 1, wherein the antioxidant is selected from the group consisting of alkylated phenols, aryl amines, and mixtures thereof.

16. The method of treating an elastane-containing fabric according to claim 15, wherein the alkylated phenol is a hindered phenol selected from the group consisting of 2,6-bis(1,1-dimethylethyl)-4-methyl-phenol; C₁-C₁₈ linear or branched alkyl esters of 3,5-bis(1,1-dimethylethyl)-4-hydroxy-benzenepropanoic acid; and mixtures thereof.

17. The method of treating an elastane-containing fabric according to claim 16, wherein the hindered phenol is 2,6-bis(1,1-dimethylethyl)-4-methyl-phenol.

18. The method of treating an elastane-containing fabric according to claim 16, wherein the treatment liquor has a surfactant concentration of at least 50 ppm and the surfactant comprises anionic surfactants, nonionic surfactants, and mixtures thereof.

19. The method of treating an elastane-containing fabric according to claim 1, wherein the fabric treatment composition comprises an adjunct ingredient selected from the group consisting of chelants, perfumes, structurants, chlorine scavengers, solvents, fabric conditioning actives, and mixtures thereof.

20. The method of treating an elastane-containing fabric according to claim 19, wherein the adjunct ingredient is a chelant.
